(19) United States
(12) Patent Application Publication
(10) Pub. No.: US 2026/0119692 A1
(43) Pub. Date: Apr. 30, 2026

(54) FIELD ACCESS CONTROL FOR APPLICATION PROGRAMMING INTERFACES THROUGH FILTERING OF DATA STRUCTURE FIELDS

(71) Applicant: ADP, LLC, Roseland, NJ (US)

(72) Inventors: Clei Souza, Porto Alegre (BR); Cesar Zanette, Porto Alegre (BR); Matheus Redecker, Porto Alegre (BR); Joao Lima, Porto Alegre (BR); Carlos Silva, Porto Alegre (BR); Dinah Portella, Porto Alegre (BR); Joao Povoa, Porto Alegre (BR); Cesar Brito, Porto Alegre (BR); Deivith Maia, Porto Alegre (BR); Bruno Oliveira, Porto Alegre (BR)

(21) Appl. No.: 19/003,146

(22) Filed: Dec. 27, 2024

Related U.S. Application Data
(60) Provisional application No. 63/615,593, filed on Dec. 28, 2023.

(51) Int. Cl. G06F 21/62; G06F 9/54

(52) U.S. Cl. CPC G06F 21/6218; G06F 9/54

(57) ABSTRACT

Technical solutions are directed to an application for field access control of APIs using data structure filtering. An application can identify an application programming interface (API) call from a second application requesting data entries and can receive, an API response destined for the second application. The API response can include a data structure with fields including the data entries. The application can select, responsive to the API response, an access profile associated with the client account and determine that the client account is not granted access to a data entry included in a field of the data structure. The application can modify, in response to the determination, the API response to exclude from the data structure the field or the data entry and transmit, to the second application, the modified API response excluding the field or the entry from the data structure.

### CROSS-REFERENCE TO RELATED APPLICATION

This application claims the benefit of priority under 35 U.S.C. § 119 to U.S. Provisional Patent Application No. 63/615,593, filed Dec. 28, 2023, which is incorporated herein by reference in its entirety and for all purposes.

### TECHNICAL FIELD

This disclosure is directed to computing technology, and particularly to improving computing security in executing access and data management operations by using script based application programming interface (API) filtering.

### BACKGROUND

APIs can be used in various network communication products or services to call upon functions to implement application functionality or services. Controlling access to various aspects of API data can be challenging.

### SUMMARY

Aspects of this technology are directed to improvements of security and access control of data management operations implemented via script-based API filtering. When remote applications use API calls to request data entries from data management applications providing such requested data via API responses, it can be challenging to selectively control access to individual data fields within the provided API response data structures. Further, selective access control is technically challenging in systems in which data management applications are integrated with a large number of other applications so as to not include adequate access control solutions for selective filtering of individual data entries in the API response data structures. In such instances, for example, requesting applications may receive data which such applications may or may not have access to receive. For example, a requesting application may be granted access to only some of the requested data entries, while remaining data entries may be inaccessible for a variety of reasons. When a data management application services to various international entities or clients, some of which may located in the areas in which local, regional or country regulations or laws, limit the types of data which those entities or clients may access, compliance with local regulations can become a challenge. Such multi-regional compliance can be made even more difficult taking in consideration that any of these regulations or laws around the world may change at any time, making selective control of data entry access in API response data structures all the more difficult, yet important to provide.

The technical solutions of the present disclosure overcome these challenges using an application-level script-based filtering of data entries of API response data structures from the data management applications prior to their transmission to the requesting application. The technical solutions can utilize an access control application intervening between the requesting application and the data management application. The access control application can include a field access control (FAC) functionality for data structure (e.g., JSON object) filtering. The access control application can monitor API traffic between the requesting applications and the data management applications, intercepting API responses from the data management applications to provide selective filtering of the data entries included in the API response data structures responsive to requesting application's API calls. The intervening access control application can identify the client account associated with the data entries and, utilizing an access profile associated with the client account, determine if the client account is granted access to the data entries requested. When the access control application identifies one or more fields of the API response data structure comprising data entries to which the client account is not granted access, the access control application can modify the API response to exclude from its data structure the one or more fields of the data entries to which the client account is not granted access. The access control application can then utilize an API module to transmit to the requesting application the modified API response data structure excluding the fields to which the requesting application did not have access, thereby providing to the requesting application the desired service without compromising the data security.

An aspect of the technical solutions is directed to a system. The system can include one or more processors, coupled with memory, to identify, by a first application for control of data access of a second application associated with a client account, an application programming interface (API) call requesting a plurality of data entries from a third application. The one or more processors can receive, by the first application from the third application, in response to the API call, an API response destined for the second application. The API response can include a data structure that includes a plurality of fields including the plurality of data entries. The one or more processors can select, by the first application, responsive to the API response, an access profile from a plurality of access profiles, wherein the access profile is associated with the client account. The one or more processors can determine, by the first application using the access profile, that the client account is not granted access to one or more data entries of the plurality of data entries included in one or more fields of the plurality of fields. The one or more processors can modify, by the first application in response to the determination, the API response to exclude from the data structure the one or more fields. The one or more processors can transmit, by the first application to the second application associated with the client account, in response to the API call, the modified API response excluding the one or more fields from the data structure.

The one or more processors can determine that that client account is granted access to a second one or more data entries of the plurality of data entries included in a second one or more fields of the plurality of fields of the data structure. The one or more processors can determine, responsive to the determination that the client account is granted access to the second one or more data entries, to leave the second one or more fields unchanged in the data structure. The access profile can be configured to indicate, for the first application, from the plurality of data entries, at least one of: the one or more data entries to which the second entity is not granted access or a second one or more data entries to which the second entity is granted access.

The third application can be a data management application configured to store the plurality of data entries and provide, to the second application responsive to the API call of the second application, the plurality of data entries. The one or more processors can be configured to select, by the first application responsive to identifying at least one of: the second application, the client account, or the plurality of data entries of the client account, the access profile. The one or more processors can be configured to determine, by the first application using the access profile, to intercept the API response for modification of the API response prior to transmission of the modified API response to the second application.

The one or more processors can be configured to identify, by the first application parsing at least one of the API call or the API response, at least one of the client account or the plurality of data entries requested by the second application. The one or more processors can be configured to intercept, by the first application responsive to determining that the client account is associated with the access profile indicating at least one of the second application or the client account, the API response from the third application destined for the second application.

The one or more processors can be configured to generate, by the first application, a query for a database relating the plurality of client accounts that include the client account with the plurality of access profiles that include the client profile. The one or more processors can be configured to receive, by the first application from the database responsive to the query, an indication that the second application is not granted access to at least one entry of the client account associated with the access profile.

The one or more processors can be configured to identify, from the plurality of fields included in the API response, a field of the access profile associated with the client account. The one or more processors can be configured to determine, based on an indication for the field of the access profile, to exclude from the data structure the field to which the second application is not granted access. The one or more processors can be configured to identify, from the plurality of fields included in the API response, a second field of the access profile associated with the client account. The one or more processors can be configured to determine, based on a second indication for the second field of the access profile, to not exclude from the data structure the second field to which the second application is granted access.

The one or more processors can be configured to identify, by the first application, a format of the data structure of the API response destined for the second application. The one or more processors can be configured to modify, by the first application, the data structure of the API response to remove from the data structure the one or more fields while maintaining the format of the data structure. The format of the data structure can be a JavaScript Object Notation (JSON) object format.

The one or more processors can be configured to identify, by the first application that the API response from the third application includes an indication of an error. The one or more processors can be configured to maintain the indication of the error unchanged in data structure of the modified API response. The one or more processors can be configured to identify, by the first application, a log for recording the modified API response. The one or more processors can be configured to store, within the log, one or more indications of the one or more fields excluded from the data structure.

The one or more processors can be configured to encode, by the first application, the data structure of the modified API response in a format that is compatible with a security protocol of at least one of: the client account or the second application. The modified API response can be transmitted to the second application in response to the encoding of the modified API response. The one or more processors can be configured to identify, by the first application, an error condition based on a discrepancy of the modified API response. The one or more processors can be configured to generate, by the first application, an error message for the modified API response based on the error condition.

An aspect of the technical solutions is directed to a method. The method can include identifying, by one or more processors coupled with memory via a first application for control of data access of a second application associated with a client account, an application programming interface (API) call requesting a plurality of data entries from a third application. The method can include receiving, by the one or more processors from the third application in response to the API call, an API response destined for the second application, the API response including a data structure that includes a plurality of fields including the plurality of data entries. The method can include selecting, by the one or more processors, responsive to the API response, an access profile from a plurality of access profiles, wherein the access profile is associated with the client account. The method can include determining, by the one or more processors using the access profile, that the client account is not granted access to one or more data entries of the plurality of data entries included in one or more fields of the plurality of fields. The method can include modifying, by the one or more processors in response to the determination, the API response to exclude from the data structure the one or more fields. The method can include transmitting, by the one or more processors to the second application associated with the client account, in response to the API call, the modified API response excluding the one or more fields from the data structure.

The method can include determining, by the one or more processors, that that client account is granted access to a second one or more data entries of the plurality of data entries included in a second one or more fields of the plurality of fields of the data structure. The method can include determining, by the one or more processors responsive to the determination that the client account is granted access to the second one or more data entries, to leave the second one or more fields unchanged in the data structure.

The second application can be an application associated with a second entity that is different than an entity associated with the client account and the access profile is configured to indicate, for the first application, from the plurality of data entries, at least one of: the one or more data entries to which the second entity is not granted access or a second one or more data entries to which the second entity is granted access. The third application can include a data management application configured to store the plurality of data entries and provide, to the second application responsive to the API call of the second application, the plurality of data entries.

The method can include selecting, by the one or more processors, responsive to the API call identifying at least one of: the client account or the plurality of data entries of the client account, the access profile associated with the client account. The method can include determining, by the one or more processors responsive to the access profile identifying the second application, to intercept the API response transmitted by the third application and destined for the second application.

An aspect of the technical solutions is directed to a non-transitory computer-readable medium storing processor-executable instructions. The instruction, when executed by one or more processors, can cause the one or more processors to identify, by a first application for control of data access of a second application associated with a client account, an application programming interface (API) call. The API call can request a plurality of data entries from a third application. The instruction, when executed by one or more processors, can cause the one or more processors to receive, by the first application from the third application in response to the API call, an API response destined for the second application, the API response including a data structure that includes a plurality of fields including the plurality of data entries. The instruction, when executed by one or more processors, can cause the one or more processors to select, by the first application, responsive to the API response, an access profile from a plurality of access profiles, wherein the access profile is associated with the client account. The instruction, when executed by one or more processors, can cause the one or more processors to determine, by the first application using the access profile, that the client account is not granted access to one or more data entries of the plurality of data entries included in one or more fields of the plurality of fields. The instruction, when executed by one or more processors, can cause the one or more processors to modify, by the first application in response to the determination, the API response to exclude from the data structure the one or more fields. The instruction, when executed by one or more processors, can cause the one or more processors to transmit, by the first application to the second application associated with the client account, in response to the API call, the modified API response excluding the one or more fields from the data structure.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 illustrates a block diagram of an example system for providing field access control of API responses using filtering of data structures;

FIG. 2 is an illustrative example of a system for providing field access control (FAC) for APIs using JSON field filtering;

FIG. 3 illustrates a block diagram of an example computing system for implementing the embodiments of the present solution, including, for example, the system depicted in FIG. 1, and the method depicted in FIG. 2;

FIG. 4 is an illustrative example of a method for providing FAC for APIs using JSON field filtering;

FIG. 5 illustrates an example flow diagram of a method for providing field access control of API responses using filtering of data structures;

FIG. 6 illustrates an example user interface output of an access profile with fields for a data structure; and

FIG. 7 illustrates an example user interface output of an access profile with fields and data entries for a data structure.

### DETAILED DESCRIPTION

When remote applications use API calls to request data entries from data management applications that provide the requested data via API responses, it can be difficult to provide the requested API responses while also protecting from unauthorized access those data fields within the provided API response data structures to which the requesting application does not have access. Such selective access control is even more challenging when data management applications are integrated within a system in which selective data entry level access control is not utilized, leaving an opening for requesting applications to receive data to which these applications may not have access. This technology can overcome these challenges using an application-level script-based filtering of data entries of API response data structures prior to their transmission to the requesting application.

In doing so, the technical solutions allow for utilization of a data management application that may not be configured with an API date entry level access control. For instance, when a client application API call requests data entries, it can be difficult to provide the requested API responses with JSON data structures providing data which the client is authorized to access, while also preventing the client from accessing those data entries included in the same API response data structure which the client is not allowed to access. These technical solutions can provide an access control application that includes a field access control to allow for granular data entry level access control across applications using APIs for data exchange.

Data management applications can provide, via API responses, data structures, such as JSON-formatted structures having fields that store confidential or secure data, such as sensitive information corresponding to medical data, personal account data, tobacco usage, ethnicity, religion, or other background information, and work-related data, such as base salary and job code. When an account associated with the API call is granted access to some, but not all of the API field data, the data management application can provide the API response without having the ability to accurately control the access to only those data entries to which the requesting application is granted access. In such instances, it is beneficial to restrict access to the portion of data which the requesting application should not receive, while still providing the portion of the data structure (e.g., the JSON structure) with the data which the requesting application should receive.

An access control application of the technical solutions can be deployed as an intervening application between the requesting applications and the data management application to control and filter the access to the information based on the granted access of the requesting application or the associated client account. The access control application can include or utilize a field access control (FAC) to address API control functionalities allowing the requesting application or its associated client to access only those API fields to which user is given access, while leaving other fields hidden from user's view. The technical solutions can satisfy emerging data privacy rules or standards in specific geographic regions, by incorporating filtering of JSON responses based on a predefined list of fields to which a requesting application or its associated client account is granted access, which can be independent from the user access configuration process. For instance, the FAC, integrated into the processing of API responses, can dynamically filter the payload received from the system of records (SOR), removing unauthorized fields while maintaining the overall JSON structure intact, allowing the requesting application to utilize the data it receives. The list of accessible fields can be stored, for example, as client account access profiles, in a database for improved efficiency, eliminating per-request transmission of the list. The solutions can provide an automated process, executed seamlessly as part of API call processing, reducing the usage of application-specific knowledge, and making it applicable to any API Gateway that may utilize such access control. By centralizing field access control in a reusable component separate from the application, the solutions can minimize development efforts, enhance response times by reducing payload sizes, and provide a solution access control API platform that is sufficiently versatile to be applied to any data-transferring application using data structures, such as JSON data structures, which may be not limited to APIs.

The data requested by API calls can include various confidential or sensitive data, such as employee's medical information, tobacco usage, ethnic or other background, work assignment data, such as employee's base salary, work location, or job code. Sometimes, it can be desirable to secure such confidential or sensitive data, barring its access and allowing the API caller to access only the data the caller has a valid business reason to access. In some geographical areas (e.g., states or countries), data privacy laws or regulations may seek protection of certain types of data, thereby making technical solutions, such as these, desirable. The API level control may be insufficient to achieve this kind of access control granularity, as the API caller may have a valid business reason to access some of the fields that go into the same category, but not all of the fields of this category. For example, the caller may have access to the worker mobile phone (e.g., to send notifications about a payroll process, for instance), but not have access to worker's address or bank account data. Another example can include a work assignment data, as many callers would have access to the worker's work location, but not to the base remuneration amount.

In some configurations, API access control systems can be limited to handling the API access control only at API and method levels, allowing access only to the authorized user or client accounts to access each API or method. However, in such configurations, once the authorized user account has been granted the access to a given API, the client or its requesting application can access every field of its API response with no limitations. By providing a field access controller for APIs to control client access through JSON filtering, the solutions can provide a data entry level of access control that is not available in such API access control configurations. For example, a technical solution can utilize the API response, JSON script and a list of fields (e.g., access profiles) to identify data to which the client and its application has access, filtering from every API call response those fields that the user is not allowed to see, thus providing a more efficient and effective level of access control for APIs.

This process can be fully automated and executed as part of the processing of the response of an API call made by the client, without significantly increasing the processing time. There may be no application specific knowledge needed for this processing, so we could apply this solution to any API Gateway that needs to have this level of access control. With this field access control centralized in a single component independent from the application or SOR, the technical solution can reduce the development needed in the application, as the FAC handles this logic in a single point reusable between any system communicating with it.

With this kind of response filtering, the technical solutions can achieve lower response times for the client's calls to the APIs, due to smaller payloads, resulting in lower transport times. For instance, in some implementations the solution may not use even half of the available fields for a given API. Furthermore, this solution can be applied to any application using a script (e.g., JSON) to transfer data, not only to APIs but other similar middleware product or features as the solution may be independent of any API specific features or behavior.

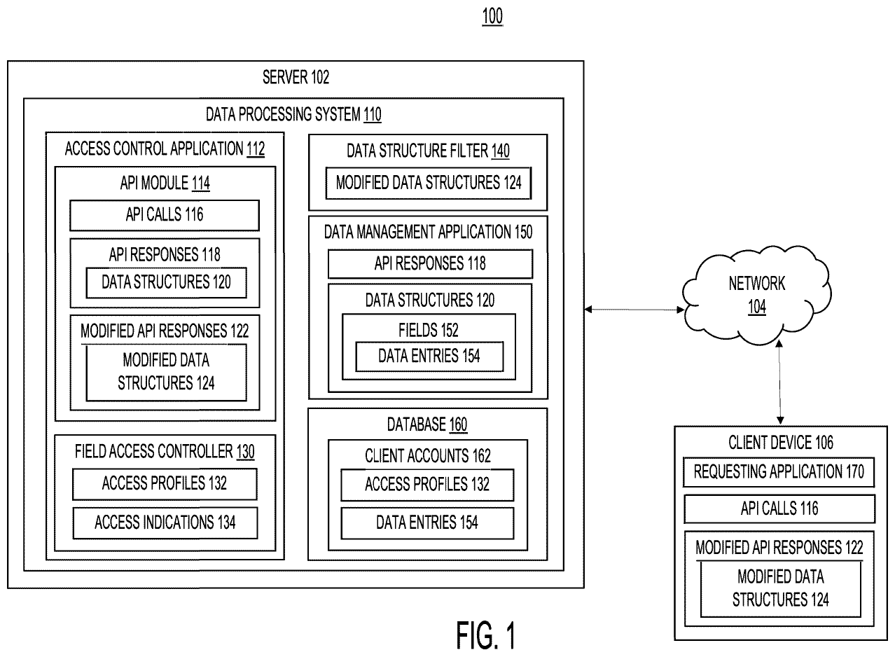

FIG. 1 illustrates an example system 100 for providing field access control of application programming interface (API) responses through filtering of data structure fields. The example system 100 can include one or more servers 102 communicating, via one or more networks 104, with one or more client devices 106. A server can include, execute or provide one or more data processing systems 110 that can include one or more of: access control applications 112, field access controllers 130, data structure filters 140, data management applications 150 and databases 160. A data management application 150 can receive, via an API module 114 of the access control application 112, API calls 116 from requesting applications 170 of client devices 106 seeking access to data entries 154 associated with client accounts 162 on a database 160 of the data processing system 110. In response to the API calls 116 requesting access to the data entries 154, the data management application 150 managing access to database 160 can generate API responses 118 having data structures 120 whose fields 152 include the requested data entries 154. An access control application 112 can include one or more API modules 114 for monitoring, identifying, receiving or transmitting API calls 116 from the requesting applications 170. The access control application can monitor, identify and receive API responses 118 with the data structures 120 provided by the data management applications 150 and transmit to the requesting application modified API responses 122 that include the modified data structures 124 whose fields 152 were filtered by the data structure filter 140 based on the determination by the FAC 130 on the accessibility of each of the requested data entries 154. A field access controller (FAC) 130 can include, utilize or operate one or more access profiles 132 with access indications 134 to determine whether the requesting application 170, its associated client account 162 or its entity is granted access to the requested data entries 154. Based on the FAC 130's determination of accessibility for each of the data entries 154 of the fields 152 of the data structure 120 of the API response 118, a data structure filter 140 can filter out from the data structure 120 of the API response 118 those fields 152 whose data entries 154 the requesting application 170 is not granted access and generate the modified data structure 124 for a modified API response 122 to be transmitted to the requesting application 170 in response to the API call 116.

Across the network 104, the client device 106 can include, execute or provide one or more requesting applications 170 for requesting, via API calls 116, from the data management application 150 of the server 102, data from the data entries 154 stored on the database 160 of the server 102. Based on the operations of the data processing system 110 and its components, the requesting application 170 of the client device 106 can receive from the server 102, modified API responses 122 with modified data structures 124 whose fields 152 are filtered to include only those data entries 154 which the requesting application 170 is permitted to access.

Server 102 can be any combination of hardware and software for providing resources, data, or services, such as services or functions of a data processing system 110, to client devices 106, over a network 104. For example, a server 102 can include one or more physical machines or one or more virtual machines running on a cloud infrastructure. The server 102 can be a specialized computer or software that provides resources, including details related to functions such as payroll processing, employee recruitment, and personnel management, among others. Servers are generally utilized to store data, facilitate applications, and offer services to clients. The server 102 can execute various applications and services, such as features or components of the data processing systems 110, to handle requests from client devices 106 (e.g., API calls 116) and provide modified API responses 122 with modified data structures 124 in response to such requests. Server 102 can manage and store data, receive and process API calls 116 (e.g., via API module 114), generate API responses 118 with data structures 120 (e.g., via data management application 150), implement data structure field level filtering of the data entries 154 of the data structure 120 (e.g., via field access controller 130 and data structure filter 140) to generate modified API responses 122 with modified data structures 124 to be provided to the client device 106 as the response. The server 102 can provide a platform for the data processing system 110 across one or more computing devices or environments, including for example any number of server devices that can be dedicated for running any number of data management applications 150 for servicing any number of client devices 106.

Data processing system 110 can include any combination of hardware and software for providing field access control of API responses via selective filtering of data structure fields based on accessibility settings of client applications. For example, a data processing system 110 can provided by one or more servers 102 executing various applications and services. The data processing system 110 can include components such as access control applications 112, field access controllers 130, data structure filters 140, data management applications 150, and databases 160. The data processing system 110 can handle API calls 116 received from various requesting applications 170, intercept API responses 118 with data structures 120 generated by data management applications 150 and provide modified API responses 122 with modified data structures 124 to be serviced to the requesting applications 170 responsive to the API calls 116. While generating the modified responses 122, the data processing system 110 can utilize the field access controller 130 to manage access control and data filtering to ensure that only authorized data entries 154 are included in the modified data structures 124 of the modified API responses 122. For example, the data processing system 110 include a field access controller 130 to use access profiles 132 associated with the client account 162 corresponding to the API call 116 to determine the accessibility of the data entries 154 in the data structure 120 of the API responses 118, as well as the data structure filter 140 to generate the modified API response 122 with a modified data structure 124 that includes only those fields 152 of the data structure 120 whose data entries 154 the requesting application 170 is authorized to access.

The data processing system 110 can include at least one processor (e.g., 310) and a memory (e.g., 315, 320 or 325), e.g., a processing circuit. The memory can store processor-executable instructions that, when executed by processor, cause the processor to perform one or more of the operations described herein. The processor can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The data processing system 110 can include one or more computing devices or servers that can perform various functions as described herein. The data processing system 110 can include any or all of the components and perform any or all of the functions of the server 102.

The data processing system 110 can include a field access controller (FAC) 114, which can include any combination of hardware and software for providing control to access to fields of APIs (e.g., API calls or API responses). Field access controller 130 can include the functionality to determine or communicate fields within an API to which a user has access and fields to which a user does not have access. The data processing system 110 can include an API module 114 that can include any combination of hardware and software for implementing API calls and API responses. API module 114 can make API calls and receive API responses between senders and receivers of APIs. API model can utilize fields identified by the FAC 130 to which a user has access to provide access to such fields and make invisible or otherwise remove from view those fields to which the user does not have access. API module 114 can receive, intercept, update or modify and transmit API calls and API responses between API recipients and senders to update any fields and ensure that only fields to which a user has access can be viewed by the user. API module can store information on fields which the user can access in a database 160 and access this information to update API calls and responses.

An access control application 112 can include any combination of hardware and software for intercepting, from data management applications 150, API responses 118 intended for requesting applications 170 and providing to the requesting applications 170 modified API responses 122 instead of the API responses 118. For example, an access control application 112 can be a software application running on a server 102 or a data processing system 110. The access control application 112 can monitor, identify, receive, and transmit API calls 116 from requesting applications 170. It can also monitor and receive API responses 118 with data structures 120 from data management applications 150. The access control application 112 can utilize an API module 114 to provide to the requesting applications 170 modified API responses 122 with modified data structures generated, created or adjusted by the data structure filter 140. The access control application 112 can use a field access controller 130 to determine the accessibility of data entries 154 based on the access profile 132 associated with the client account 162 corresponding to the API call 116 or the API response 118. For example, the access control application 112 can utilize the data structure filter 140 to generate modified API responses 122 with modified data structures 124 that exclude data structure fields 152 of the data entries 154 which the requesting application 170 (or its associated client account 162 or entity) is unauthorized to access. The entity associated with the requesting application can include any corporation, organization or enterprise associated with, or operating, the requesting application 170. The entity can be associated with the client account 162 and may have some of the data entries 154 which it can access and others which it is not permitted to access.

API module 114 can include any combination of hardware and software for handling API calls 116, intercepting the API responses 118 and providing modified API responses 122 to the requesting client devices 106 in response to the requesting API calls 116. For example, an API module 114 can be a software component of an access control application 112 or a data management application 150. The API module 114 can receive API calls 116 from requesting applications 170 and transmit them to the appropriate data management applications 150. The API module 114 can parse the API calls 116 and identify or select from a plurality of data management applications 150 across one or more servers 102, the data management application 150 associated or indicated by the API call 116. The API module 114 can receive API responses 118 generated by the data management applications 150 and provide the API responses 118 to the FAC 130 to utilize an access profile 132 associated with the client account 162 to determine which, if any, of the data entries 154 the requesting application (e.g., or its associated client account 162) does not have the permission to access. The API module 114 can work with a field access controller 130 and a data structure filter 140 to ensure that only authorized data entries 154 are provided to the requesting application 170. The API module 114 can receive the modified API response 122 having the modified data structures 124 whose fields 152 include only those data entries 154 to which the requesting application 170 (e.g., its client account 162) is granted access.

API calls 116 can include any requests made by a requesting application 170 to access data or services from a data management application 150. For example, API calls 116 include any transmissions, such as via HTTP requests sent over a network 104 to a server 102, requesting access to data entries 154 associated with a particular client account 162. The API calls 116 can include parameters specifying the data entries 154 or services requested by the client device 106. The data management application 150 can receive and process the API calls 116 and generate API responses 118 with the requested data entries 154 embedded into fields 152 of the data structure 120 of the API response 118. The API calls 116 can be monitored and intercepted by an access control application 112 to ensure that only authorized data entries 154 are included in the API responses provided to the requesting application 170, thereby generating modified API responses 122 with modified data structures 124 with filtered fields 152 having data entries 154 to which the requesting application 170 is granted access and not including those fields 152 whose data entries 154 are not permissible for the requesting application 170 to access.

API responses 118 can include any data or information provided by a data management application 150 in response to API calls 116. For example, API responses 118 can be JSON or XML data structures transmitted over a network 104 to a client device 106. The API responses 118 can include data structures 120 with fields 152 containing the data entries 154 requested or indicated by the API calls 116. The API responses 118 can include data entries 154 associated with client accounts 162 which can include or correspond to access profiles 132 that can include access indications 134 indicating which of the data entries 154 a particular client account 162, a particular requesting application 170 or a particular entity utilizing the requesting application 170 can or cannot access. The API responses 118 can be monitored and intercepted by an access control application 112 to ensure that only authorized data entries 154 are included in the modified data structures 124 of the modified API responses 122 to be provided to the requesting application 170. For example, the modified API responses 122 can exclude fields 152 with unauthorized data entries 154.

Data structures 120 can include any organized format for storing and managing data entries 154. For example, data structures 120 can be JSON structures or objects or XML objects or documents. Data structures 120 can include fields 152 designed for including or storing particular data entries 154. The data structures 120 can be generated by a data management application 150 in response to API calls 116 and included in API responses 118. The data structures 120 can be monitored and filtered by an access control application 112 to ensure that only authorized data entries 154 are included. The access control application 112 can use a field access controller 130 and a data structure filter 140 to generate modified data structures 124. For example, while a data structure 120 can include fields 152 with data entries 154 to which the requesting client, application or entity has or does not have access, the modified data structures 124 can exclude fields 152 with data entries 154 of the original data structure 120 to which the requesting application, client or entity does not have granted access.

Modified API responses 122 can include any API responses 118 that have been altered to exclude unauthorized data entries 154. For example, modified API responses 122 can be generated by an access control application 112 using a field access controller 130 to determine (e.g., via an access profile 132) which data entries 154 has the right to access and a data structure filter 140 to filter out or remove those fields 152 whose data entries 154 the requesting client, application or entity does not have access. For instance, the modified API responses 122 can include modified data structures 124 with fields 152 including only authorized data entries 154 and from which the fields 152 of data entries whose access is unauthorized are removed. The modified API responses 122 can be transmitted to requesting applications 170 in response to API calls 116. For example, the modified API responses 122 can ensure that the requesting application 170 only receives data entries 154 that it is authorized to access.

Modified data structures 124 can include any organized format for storing and managing data entries 154 to which the requesting application, client or entity is granted access. The modified data structures 124 can include any data structures 120 that have been altered to exclude unauthorized data entries 154. For example, modified data structures 124 can be generated by an access control application 112 using a field access controller 130 and a data structure filter 140. The modified data structures 124 can include fields 152 including only authorized data entries 154, such as data entries 154 that are authorized to a client account 162 associated with an API call 116, or a requesting application 170 associated with a particular entity (e.g., corporation, enterprise, organization or department of an organization). The modified data structures 124 can be included in modified API responses 122 transmitted to requesting applications 170. For example, the modified data structures 124 can ensure that the requesting application 170 only receives data entries 154 that it is authorized to access.

Field access controller 130 can include any combination of hardware and software for determining or managing access to data entries 154 in data structures 120. For example, a field access controller 130 can be a component of an access control application 112 configured to determine if data entries 154 of a generated API response 118 can be shared with (e.g., is accessible by) the requesting application 170 associated with a client account 162 or an entity (e.g., enterprise or corporation requesting the data). The field access controller 130 can use access profiles 132 with access indications 134 to determine whether a requesting application 170 is granted access to the requested data entries 154. The field access controller 130 can work with a data structure filter 140 to generate modified data structures 124 that exclude unauthorized data entries 154. For example, the field access controller 130 can ensure that only authorized data entries 154 are included in the modified API responses 122.

Access profiles 132 can include any data or information used to determine access permissions for data entries 154. Access profile 132 can include use access indications 134 to indicate which of the data entries 154 are accessible by a particular client account 162, requesting application 170, or an entity (e.g., corporation, enterprise, or department) operating the requesting application 170. A client account 162 can include a plurality of access profiles 132 for a plurality of applications 170 or plurality of entities. One or more access profiles 132 can indicate (e.g., via access indications 134) which data entries 154 can be accessed by a requesting application 170 for a given client account 162. Access profiles 132 can be configured per each client account 162, requesting application 170 or entity (e.g., client account of the entity) operating the requesting application 170. For example, access profiles 132 can be stored in a database 160 and used by a field access controller 130. The field access controller 130 can use the access profiles 132 to filter data structures 120 and generate modified data structures 124. For example, the access profiles 132 can ensure that only authorized data entries 154 are included in the modified API responses 122.

Access indications 134 can include any data or information specifying or indicating access permissions for one or more data entries 154. For example, access indications 134 can be part of access profiles 132 used by a field access controller 130. The access indications 134 can specify which data entries 154 a requesting application 170 is authorized to access. The access indications 134 can include check marks or selections on a window display of an access profile 132 to indicate if a given data entry 154 or a field 152 is accessible by a client account 162, requesting application 170 or entity operating the requesting application 170. The field access controller 130 can use the access indications 134 to filter data structures 120 and generate modified data structures 124. For example, the access indications 134 can ensure that only authorized data entries 154 are included in the modified API responses 122.

Data structure filter 140 can include any combination of hardware and software for filtering data structures 120. Data structure filter 140 can include any functionality for removing from the data structure 120 those fields 152 whose data entries 154 are determined to not be accessible by (e.g., there is not granted access for) the requesting application 170 that sent the API request 170. For example, a data structure filter 140 can be a component of an access control application 112. The data structure filter 140 can work with a field access controller 130 to filter data structures 120 based on access profiles 132 and access indications 134. The data structure filter 140 can generate modified data structures 124 that exclude unauthorized data entries 154. For example, the data structure filter 140 can ensure that only authorized data entries 154 are included in the modified API responses 122.

Data management application 150 can include any combination of hardware and software for managing data and providing data services to requesting applications 170. Data management application 150 can be a storage management application storing data entries 154 in a database 160 and providing data entries 154 per API calls 116 (e.g., requests from the requesting application 170). For example, a data management application 150 can be a software application running on a server 102 or a data processing system 110. For instance, a data management application 150 can receive API calls 116 from requesting applications 170 and generate API responses 118 with data structures 120. The data management application 150 can manage access to data entries 154 stored in a database 160. For example, the data management application 150 can work with an access control application 112 to ensure that only authorized data entries 154 are included in the API responses 118.

Fields 152 can include any individual elements or components of data structures 120 in which data entries 154 can be provided. For example, fields 152 can be JSON or XML elements for including various data entries 154. The fields 152 can be part of data structures 120 generated by a data management application 150 in response to API calls 116. The fields 152 can be filtered by an access control application 112 to exclude unauthorized data entries 154 (e.g., the data entries 154 to which the requesting application 170 or its associated client account 162 do not have access). For example, the fields 152 can be included in modified data structures 124 that are part of modified API responses 122 including the data entries 154 that are filtered and confirmed to include data to which the requesting application 170 (e.g., or its client account 162 or the associated entity) is granted access.

Data entries 154 can include any individual pieces of data or information stored in fields 152 of data structures 120. For example, data entries 154 can be JSON or XML elements containing specific data values. The data entries 154 can be requested by API calls 116 and included in API responses 118 generated by a data management application 150. Data entries 154 can include, for example, information on employee medical records, tobacco usage, ethnic background, work assignments, base salary, job codes, social security numbers, bank account numbers, personal details such as names and addresses, passwords, email addresses, employee badge numbers, desk locations, confidential data, sensitive medical information, project timelines, sales figures, customer feedback, inventory levels, transaction histories, product specifications, marketing strategies, financial statements, legal documents, and training materials. The data entries 154 can be filtered by an access control application 112 to exclude unauthorized data. For example, the data entries 154 can be included in modified data structures 124 that are part of modified API responses 122.

Database 160 can include any organized collection of data stored and managed by a data management application 150. For example, a database 160 can be a relational database, a NoSQL database, or any other type of data storage system. The database 160 can relate the data entries 154 or fields 152 with access profiles 132 associated with client accounts 162 for which access is granted or not granted. The database 160 can be configured to receive queries (e.g., from access control application 112 or the data structure filter 140) to pull up or select an access profile 132 associated with a client account 162 corresponding to the requesting application 170 generating the API calls 116. The database 160 can include or store a log for recording modified API responses 122, modified data structures 124, data entries 154 or fields 152 which were modified and for which requesting applications 170 or client accounts 162. The database 160 can store data entries 154 associated with client accounts 162. The data management application 150 can manage access to the database 160 and generate API responses 118 with data structures 120 containing the requested data entries 154. The database 160 can be accessed and managed by an access control application 112 to ensure that only authorized data entries 154 are included in the API responses 118.

The database 160 can include various data of users, including public or confidential data. Database 160 can include or store information or data on users, such as employees of an enterprise. The stored data can include names, social security numbers, bank account numbers, medical information, personal information, passwords for online accounts (e.g., emails) or other personal or confidential data. The stored data can include employee badge numbers, desk locations in an enterprise, email addresses or other public information. Data stored in database 160 can be accessed or modified via API calls and API responses (e.g., data from fields in APIs).

The database 160 can be accessed using one or more memory addresses, index values, or identifiers of any item, structure, or region maintained in the database 160. The database 160 can be accessed by the components of the data processing system 110, or any other computing device described herein. In some implementations, the database 160 can be internal to the data processing system 110. In some implementations, the database 160 can exist external to the data processing system 110 and can be accessed via the network 104. In some implementations, the data processing system 110 can store, in one or more regions of the memory of the data processing system 110, or in the database 160, the results of any or all computations, determinations, selections, identifications, generations, constructions, or calculations in one or more data structures indexed or identified with appropriate values. Any or all values stored in the database 160 can be accessed by any computing device described herein, such as the data processing system 110, to perform any of the functionalities or functions described herein. In implementations where the database 160 forms a part of a cloud computing system, the database 160 can be a distributed storage medium in a cloud computing system and can be accessed by any of the components of the data processing system 110, by one or more client devices 106, or by any other computing devices described herein.

Client accounts 162 can include any data or information associated with individual clients, users, applications or entities. Client account 162 can include an account of a user of a client device 106, an account of a requesting application 170, or an account of an entity utilizing the requesting application 170. For example, client accounts 162 can include user profiles, access permissions (e.g., access profiles 132), and other account-related data. The client accounts 162 can be stored in a database 160 and managed by a data management application 150. The access control application 112 can use access profiles 132 associated with client accounts 162 to determine the accessibility of data entries 154. For example, the access control application 112 can ensure that only authorized data entries 154 are included in the modified API responses 122.

Client device 106 can include any combination of hardware and software for accessing data and services over a network 104. For example, a client device 106 can be a smartphone, tablet, laptop, or desktop computer. The client device 106 can execute requesting applications 170 that make API calls 116 to data management applications 150. The client device 106 can receive API responses 118 with data structures 120 containing the requested data entries 154. The client device 106 can work with an access control application 112 to ensure that only authorized data entries 154 are included in the API responses 118. For example, the client device 106 can receive modified API responses 122 with modified data structures 124.

Each of the client devices 106, as well as the servers 102 or any other computing devices providing data processing system 110, can include at least one processor and a memory, e.g., a processing circuit. The memory can store processor-executable instructions that, when executed by processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client devices 106 can include one or more computing devices or servers that can perform various functions as described herein. The one or more client devices 106 can include any or all of the components and perform any or all of the functions described herein.

Each client device 106 can include, but is not limited to, a mobile device (e.g., a smartphone, tablet, etc.), a television device (e.g., smart television, set-top box, etc.), a personal computing device (e.g., a desktop, a laptop, etc.), or another type of computing device. Each client device 106 can be implemented using hardware or a combination of software and hardware. Each client device 106 can include a display or display portion, which can be a display portion of a television, a display portion of a computing device, or another type of interactive display (e.g., a touchscreen, a display, etc.) and one or more input or output (I/O) devices (e.g., a mouse, a keyboard, digital keypad). The display can include a touch screen displaying an application and can have a border region (e.g., side border, top border, bottom border). Client device 106 or DPS 110 can include, communicate with, or execute an application, such as an API application 112 that can utilize APIs for its communication. The application can include a web application, a server application, a resource, a desktop, or a file. In some implementations, the application can include a local application (e.g., local to a client device 106), hosted application, Software as a Service (SaaS) application, virtual application, mobile application, and other forms of content. In some implementations, the application can include or correspond to applications provided by remote servers or third-party servers. Each of the client devices 106 can be computing devices configured to communicate via the network 104 to access information resources, such as web pages via a web browser, or application resources via a native application executing on a client device 106. When accessing information resources, the client device 106 can execute instructions (e.g., embedded in the native applications, in the information resources, etc.) that cause the client devices 106 to display application interfaces.

Requesting application 170 can include any software application that makes API calls 116 to access data and services. For example, a requesting application 170 can be a mobile app, a web app, or a desktop application. The requesting applications 170 can include any human resources or a payroll application including, for example, employee self-service portals, payroll processing systems, benefits administration tools, time and attendance tracking software, performance management applications, recruitment and onboarding platforms, expense management systems, compliance reporting tools, workforce analytics dashboards, or mobile human resources application. The requesting application 170 can run on a client device 106 and make API calls 116 to data management applications 150. The requesting application 170 can receive API responses 118 with data structures 120 containing the requested data entries 154. The requesting application 170 can work with an access control application 112 to ensure that only authorized data entries 154 are included in the API responses 118. For example, the requesting application 170 can receive modified API responses 122 with modified data structures 124.

A network 104 can include any combination of hardware and software for facilitating communication between devices. For example, a network 104 can be the internet, a local area network (LAN), a wide area network (WAN), or any other type of communication network. The network 104 can connect servers 102, client devices 106, and other components of the system 100. The network 104 can facilitate the transmission of API calls 116 and API responses 118 between requesting applications 170 and data management applications 150. The network 104 can also support secure communication protocols to protect data during transmission. For example, the network 104 can use encryption to secure API calls 116 and API responses 118. The network 104 can include computer networks such as the Internet, local, wide, metro or other area networks, intranets, satellite networks, other computer networks such as voice or data mobile phone communication networks, and combinations thereof. The data processing system 110 of the system 100 can communicate via the network 104, for example with one or more client devices 106. The network 104 can be any form of computer network that can relay information between the data processing system 110, the one or more client devices 106, and one or more information sources, such as web servers or external databases, amongst others. In some implementations, the network 104 can include the Internet or other types of data networks, such as a local area network (LAN), a wide area network (WAN), a cellular network, a satellite network, or other types of data networks. The network 104 can also include any number of computing devices (e.g., computers, servers, routers, network switches, etc.) that are configured to receive and or transmit data within the network 104.

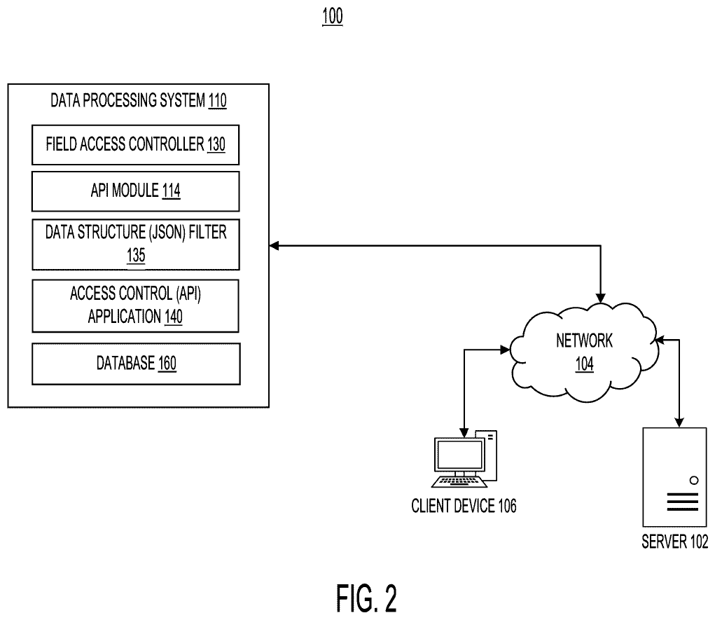

FIG. 2 is an illustrative example system 200 for providing an example of a FAC for APIs using, for example, JSON field filtering. The system 100 can include at least one data processing system (DPS) 110, at least one network 104, and one or more client devices 106. Each of the components (e.g., the data processing system 110, the network 104, the client devices 106, etc.) of the system 100 can be implemented using the hardware components or a combination of software with the hardware components of a computing system 300. For instance, a computing system 300 can provide the hardware and software structure for a DPS 110, client device 106 or server 102. The data processing system 110 can include at least one field access controller 130, at least one API module 114, at least one data structure (e.g., JSON) filter 140, at least one API application 112, and a database 160.

Data structure filter 140, which can also include or be referred to as a JSON filter 140, can include any combination of hardware and software and be combined with field access controller 130 for determining which fields of APIs to make visible or available or invisible or unavailable for particular users. JSON filter 140 can operate individually or with API module 114 to implement any changes to API calls or API responses to provide access control (e.g., make certain fields inaccessible or invisible to the user and make others available and visible). JSON filter 140 can access data on particular fields for each user accessing APIs from a database 160.

Access control application 112, which can be referred to as the API application 112, can include any application executing on a client device 106, server 102 or DPS 110 that utilizes APIs and for which the DPS 110 can control access to various fields of APIs. API application 112 can include an agent operating on one device and communicating with an application on another device and vice versa. API application 112 can make API calls and receive API responses, which the API module 114 can intercept and modify per JSON filter 140 determinations.

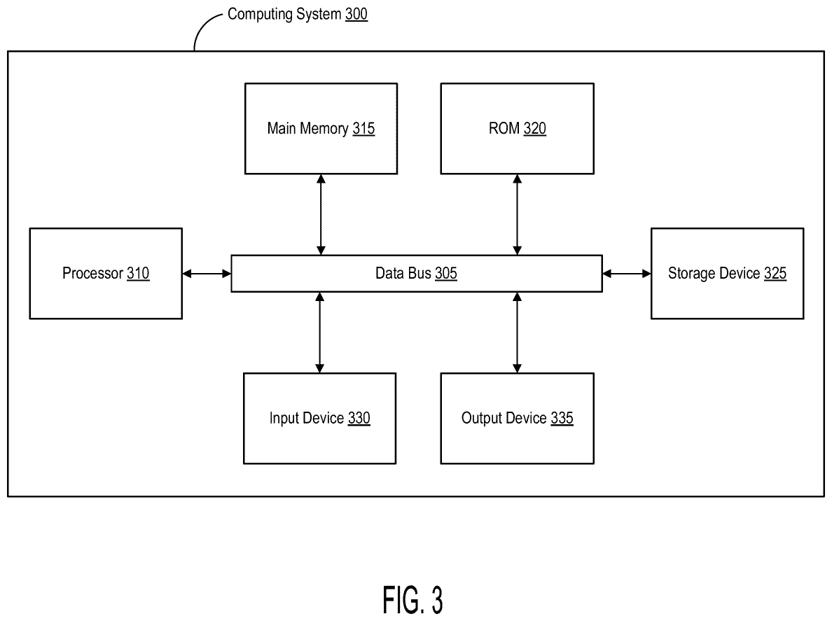

FIG. 3 illustrates a block diagram of a computing system 300 for implementing the embodiments of the technical solutions discussed herein, in accordance with various aspects. FIG. 3 illustrates a block diagram of an example computing system 300, which can also be referred to as the computer system 300. Computing system 300 can be used to implement elements of the systems and methods described and illustrated herein. Computing system 300 can be included in and run any device (e.g., a server, a computer, a cloud computing environment or a data processing system).

Computing system 300 can include at least one bus data bus 305 or other communication device, structure or component for communicating information or data. Computing system 300 can include at least one processor 310 or processing circuit coupled to the data bus 305 for executing instructions or processing data or information. Computing system 300 can include one or more processors 310 or processing circuits coupled to the data bus 305 for exchanging or processing data or information along with other computing systems 300. Computing system 300 can include one or more main memories 315, such as a random access memory (RAM), dynamic RAM (DRAM), cache memory or other dynamic storage device, which can be coupled to the data bus 305 for storing information, data and instructions to be executed by the processor(s) 310. Main memory 315 can be used for storing information (e.g., data, computer code, commands or instructions) during execution of instructions by the processor(s) 310.

Computing system 300 can include one or more read only memories (ROMs) 320 or other static storage device 325 coupled to the bus 305 for storing static information and instructions for the processor(s) 310. Storage devices 325 can include any storage device, such as a solid state device, magnetic disk or optical disk, which can be coupled to the data bus 305 to persistently store information and instructions.

Computing system 300 can be coupled via the data bus 305 to one or more output devices 335, such as speakers or displays (e.g., liquid crystal display or active matrix display) for displaying or providing information to a user. Input devices 330, such as keyboards, touch screens or voice interfaces, can be coupled to the data bus 305 for communicating information and commands to the processor(s) 310. Input device 330 can include, for example, a touch screen display (e.g., output device 335). Input device 330 can include a cursor control, such as a mouse, a trackball, or cursor direction keys, for communicating direction information and command selections to the processor(s) 310 for controlling cursor movement on a display.

The processes, systems and methods described herein can be implemented by the computing system 300 in response to the processor 310 executing an arrangement of instructions contained in main memory 315. Such instructions can be read into main memory 315 from another computer-readable medium, such as the storage device 325. Execution of the arrangement of instructions contained in main memory 315 causes the computing system 300 to perform the illustrative processes described herein. One or more processors 310 in a multi-processing arrangement can also be employed to execute the instructions contained in main memory 315. Hard-wired circuitry can be used in place of or in combination with software instructions together with the systems and methods described herein. Systems and methods described herein are not limited to any specific combination of hardware circuitry and software.

Although an example computing system has been described in FIG. 3, the subject matter including the operations described in this specification can be implemented in other types of digital electronic circuitry, or in computer software, firmware, or hardware, including the structures disclosed in this specification and their structural equivalents, or in combinations of one or more of them.

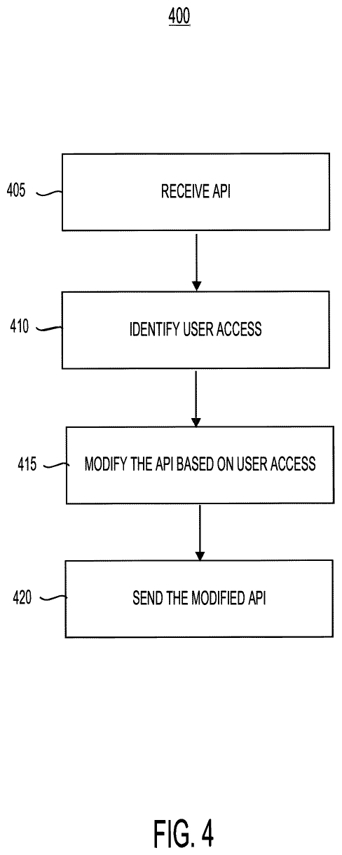

FIG. 4 is an illustrative example of a method 400 for providing field access control (FAC) for APIs using JSON field filtering. The method 400 can be performed by one or more processors. The method 400 can be performed by one or more systems or components depicted in FIGS. 1-3. The method can include the one or more processors receiving an API, such as receiving, from a sender or a device operating a data management application, an API response for an API call, where the API response comprises a data structure (e.g., a JSON structure) having a plurality of fields that include data requested by the API call (act 405). The method can include the one or more processors using access profiles associated with the client account to identify or determine a user access, such as identifying individual requested data entries for a first one or more fields of the plurality of fields of the data structure for which access is granted to the requesting party and a second one or more fields of the plurality of fields including data entries for which the access is not granted to the requesting party(act 410). The method can include the one or more processors modifying the API based on the user access, such as modifying the API response to at least one of: obfuscate, make inaccessible or remove data from the second one or more fields of the data structure, in response to the identification or determination of the user (act 415). The method can include the one or more processors sending the modified API, such as sending the modified API response with the modified data structure including only fields or data entries for which access is granted, to the recipient or requesting party or a device. (act 420).

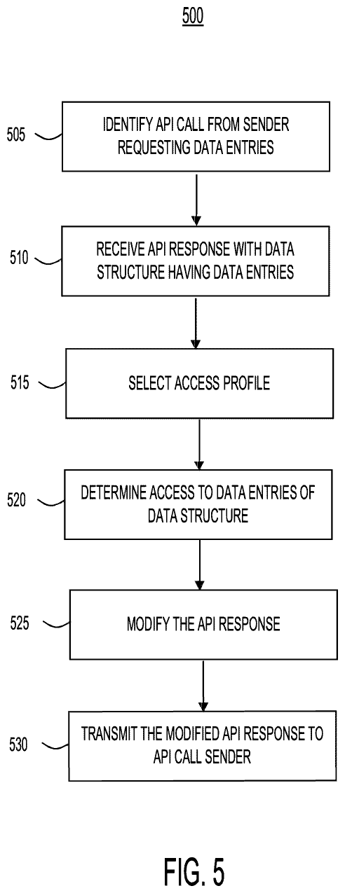

FIG. 5 illustrates an example flow diagram of a method 500 for providing field access control of application programming interface (API) responses via filtering of data structure fields. The method 500 can be implemented using, for example, system examples or features discussed in connection with FIGS. 1-3. The method 500 can be implemented, using for example, one or more processors (e.g., 310) coupled with memory (e.g., 315, 320 or 325) which can store or include various instructions, computer code or data to trigger or cause the one or more processors (e.g., 310) to implement the acts or operations of the method 500, such as acts 505-530. At act 505, the method can include identifying an API call from a sender requesting data entries. At act 510, the method can include receiving an API response having a data structure with the requested data entries. At act 515, the method can include selecting an access profile. At 520, the method can include determining access to data entries of the API response data structure. At 525, the method can include modifying the API response, responsive to the determination at 520. At 530, the method can include transmitting the modified API response to the API call sender.

At act 505, the method can include identifying an API call from a sender requesting data entries. The method can include one or more processors coupled with memory (e.g., and configured via instructions, code or data stored at the memory to implement) identifying, via a first application for control of data access of a second application associated with a client account, an application programming interface (API) call. The API call can request one or more (e.g., a plurality) of data entries from a third application (e.g., a data management application). The first application can be an access control application of the data processing system. The second application can be a requesting application from a remote client device requesting access to one or more data structures. The third application can be a data management application receiving API calls and providing requested data entries to the requesting applications.

The one or more processors can execute the data processing system comprising the access control application that can include an API module to receive API calls from various requesting applications of various client devices. The requesting applications can be, for example, employee self-service portals, payroll processing systems, benefits administration tools, time and attendance tracking software, performance management applications, recruitment and onboarding platforms, expense management systems, compliance reporting tools, workforce analytics dashboards, mobile HR apps, leave management systems, training and development applications, employee feedback systems, compensation management tools, and HR case management systems. The third application can be a data management application configured to store the plurality of data entries and provide, to the second application (e.g., the requesting application) responsive to the API call of the second application, the plurality of data entries requested or indicated via the API call.

At act 510, the method can include receiving an API response having a data structure with the requested data entries. The method can include the one or more processors receiving, by the first application (e.g., access control application) from the third application (e.g., the data management application), in response to the API call, an API response. The API response can be destined for the second application (e.g., the requesting application). The API response can include a data structure that includes a plurality of fields including the plurality of data entries. The method can include the first application intercepting the API response having a data structure generated by the data management application that has gathered the data entries requested by the API call to construct the data structure, prior to the API response being transmitted or sent to the second application (e.g., the requesting application).

The method can include the one or more processors identifying, by the first application parsing at least one of the API call or the API response, at least one of the client account or the plurality of data entries requested by the second application. The one or more processors can intercept, by the first application, the API response from the third application destined for the second application. The method can include the first application (e.g., the access control application) intercepting the API response in response to determining that the client account is associated with the access profile indicating at least one of the second application or the client account. For instance, the access control application can determine (e.g., using a query to a database) that the client account corresponding to the API call or the API response corresponds to an access profile for which one or more access indications identify one or more data entries that are not to be shared with one or more parties, such as one or more requesting applications or one or more client accounts associated with the requesting applications or entities or other users or client accounts.

At act 515, the method can include selecting an access profile. The method can include the one or more processors selecting, by the first application (e.g., the access control application), responsive to the API response, an access profile from a plurality of access profiles. The selected access profile can be a profile that is associated with the client account, such as a client account of the client device sending the requesting application or a user using the requesting application to send the API call. The selected access profile can include a profile that is associated with the requesting application or an entity (e.g., enterprise, corporation, organization or a department) associated with the requesting application or the client account. The selected access profile can include one or more access indications for one or more data entries or data fields, such as the one or more data entries or data fields of the data structure generated by the third application (e.g., the data management application) in response to the API call requesting the one or more data entries.

The method can include the one or more processors selecting, by the first application, the access profile, responsive to identifying at least one of: the second application, the client account, or the plurality of data entries of the client account. The method can include ethe one or more processors determining, by the first application (e.g., the data structure filter or the field access controller) using the access profile, to intercept the API response generated by the third application to modify the API response prior to responding to the second application (e.g., requesting application). For instance, the field access controller can determine to intercept the API response responsive to identifying, detecting or determining, based on the contents of the API response or the request including the API call, that the requesting application is associated with the client account 162. The client account 162 can have the access profile 132 corresponding to one or more data entries or fields of the data structure indicated by the API call (e.g., from the requesting application) or the API response (e.g., from the data management application). In response to identifying a match between the access indications of the access profile indicating access for one or more data entries or fields, the first application can determine to intercept the API response and modify the data structure of the API response.

At 520, the method can include determining access to data entries of the API response data structure. The method can include the one or more processors determining, by the first application using the access profile, that the client account is not granted access to one or more data entries of the plurality of data entries included in one or more fields of the plurality of fields. For example, the field access controller of the access control application can determine, based on the access indications of the access profile corresponding to the one or more data entries or fields of the data structure of the API response, that the client account (e.g., associated with the requesting application) is not granted access to the one or more entries in the one or more fields of the data structure of the API response.

The access profile can be configured to indicate, for the first application (e.g., the access control application), from the plurality of data entries, at least one of: the one or more data entries to which the second entity (e.g., the requesting application) is not granted access or a second one or more data entries to which the second entity is granted access. The one or more processors can determine (e.g., via the field access controller) that the client account is granted access to a second one or more data entries of the plurality of data entries included in a second one or more fields of the plurality of fields of the data structure.

The method can include the one or more processors generating, by the first application, a query for a database relating the plurality of client accounts that include the client account with the plurality of access profiles that include the client profile. The method can include the first application (e.g., the access control application) receiving, from the database responsive to the query, an indication that the second application (e.g., the requesting application) is not granted access to at least one entry of the client account associated with the access profile.

The method can include the first application or the field access controller identifying, from the plurality of fields included in the API response, a field of the access profile associated with the client account. The first application or the field access controller can determine, based on an indication for the field of the access profile, to exclude from the data structure the field to which the second application is not granted access. The data structure filter can exclude, from the data structure of the API response, any number of fields to which the second application (e.g., the requesting application) is not granted access. The first application can leave the fields of the data structure unchanged, but encode, obfuscate, erase or remove the data entries from the fields of the data structure in order to protect from unauthorized access those data entries to which the client account associated with the requesting application is not granted access (e.g., as determined using the access profile).

The method can include the one or more processors identifying, from the plurality of fields included in the API response, a second field of the access profile associated with the client account. The method can include the one or more processors, determining, based on a second indication for the second field of the access profile, to not exclude from the data structure the second field to which the second application is granted access. The method can include the one or more processors, determining, based on the second indication for the second field of the access profile, to not encode, obfuscate, erase or remove those data entries from the fields of the data structure to which the second application is granted access.

At 525, the method can include modifying the API response, responsive to the determination at 520. The method can include the one or more processors modifying, by the first application in response to the determination, the API response to exclude from the data structure the one or more fields. For example, the data structure filter can remove, from the data structure of the API response, the fields or data entries for which the determination is made (e.g., at 520) that the requesting client account or the requesting application, or the entity associated with the requesting application, was not granted access. The data structure filter can leave unchanged, within the modified data structure, those fields or data entries for which the determination (e.g., at 520) is made that the client account or the requesting application or the entity associated with the requesting application, was granted access or was not denied access.

The method can include the one or more processors determining to leave the second one or more fields unchanged in the data structure. This determination can be made responsive to the determination that client account is granted access to a second one or more data entries of the plurality of data entries included in a second one or more fields of the plurality of fields of the data structure. The second one or more fields or the second one or more entries from the second one or more fields can be left unchanged or included within the modified data structure or can be included in the freshly generated modified data structure (e.g., in the instances in which the modified data structure is generated based on the original data structure).

The method can include the one or more processors identifying, by the first application (e.g., access control application), a format of the data structure of the API response destined for the second application. The format can be a JavaScript Object Notation (JSON) format. The one or more processors can modify, by the first application, the data structure of the API response to remove from the data structure the one or more fields while maintaining the format of the data structure. For instance, the modified data structure of the modified API response can be modified or adjusted so as to maintain the format of the original data structure, allowing the requesting application to seamlessly utilize the modified API response and its modified data structure.

The method can include the one or more processors identifying, by the first application that the API response from the third application includes an indication of an error.

The one or more processors can maintain the indication of the error unchanged in data structure of the modified API response. The method can include the one or more processors identifying, by the first application, a log for recording the modified API response. The method can include the one or more processors can store, within the log, one or more indications of the one or more fields excluded from the data structure.

The method can include the one or more processors encoding or encrypting, by the first application, the data structure of the modified API response in a format that is compatible with a security protocol of at least one of: the client account or the second application. The modified API response can be transmitted to the second application in response to the encoding of the modified API response. The method can include the one or more processors identifying, by the first application, an error condition based on a discrepancy of the modified API response; and generate, by the first application, an error message for the modified API response based on the error condition.

At 530, the method can include transmitting the modified API response to the API call sender. The method can include the one or more processors transmitting the modified API response excluding the one or more fields from the data structure. The modified API response with the modified data structure can be transmitted, by the first application to the second application associated with the client account, in response to the API call. For example, the API module of the access control application can transmit, to the requesting application, the modified API response with the included or embedded modified data structure that includes only those fields whose data entries were determined to include the data to which the requesting application or its associated client account was granted access. For example, the transmitted modified API data structure can include all of the fields of the original data structure, but the data entries to which the requesting application is not granted access can be removed from their respective fields, or having those fields be obfuscated, encoded or encrypted.

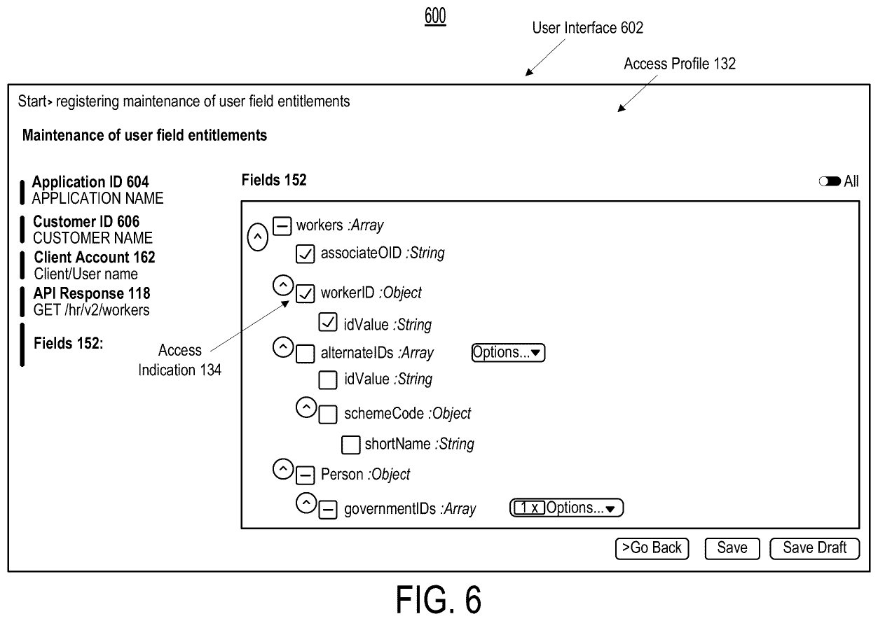

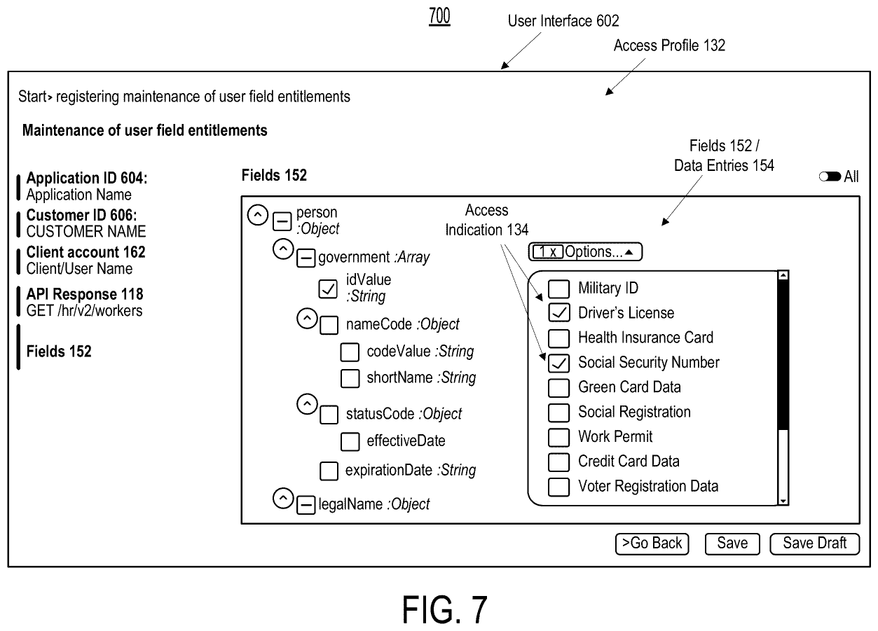

FIGS. 6 and 7 illustrate example outputs of a user interface 602 representing access profiles 132 with access indications 134 for various fields 152 of data structures 120 that can be adjusted or reconfigured into modified data structures 124. At FIGS. 6 and 7, the user interface 602 includes a window display of an example access profile 132 that can identify or be associated with a particular application identifier 604, which can correspond to any application associated with the access profile 132, such as a requesting application 170 or a data management application 150. The access profile 132 can include or identify a customer identifier 606 which can identify a name for an entity (e.g., corporation, organization or enterprise). At FIG. 6, the access profile 132 can list fields 152 that can be populated with various data entries 154 as shown in FIG. 7. The fields 152 or its data entries 154 can be indicated as accessible or inaccessible for a given client account 162, application ID 604, customer ID 606 (e.g., entity), which allows the FAC to determine which fields 152 or data entries 154 to edit out of the API response 118 to generate a modified response 122/. In FIG. 7, data entries 154 can be selected via a selection window to populate various fields 152 which can be used to finalize or configure the access profile 132.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system, comprising:
one or more processors, coupled with memory, to:
identify, by a first application for control of data access of a second application associated with a client account, an application programming interface (API) call requesting a plurality of data entries from a third application;
receive, by the first application from the third application, in response to the API call, an API response destined for the second application, the API response including a data structure that includes the plurality of data entries;
select, by the first application, responsive to the API response, an access profile from a plurality of access profiles, wherein the access profile is associated with the client account;
determine, by the first application using the access profile, that the client account is not granted access to one or more data entries of the plurality of data entries included in the API response;
modify, by the first application in response to the determination, the API response to exclude from the data structure the one or more fields; and
transmit, by the first application, to the second application associated with the client account, in response to the API call, the modified API response excluding the one or more fields from the data structure.

2. The system of claim 1, the one or more processors to:
determine that that client account is granted access to a second one or more data entries of the plurality of data entries included in the data structure; and
determine, responsive to the determination that the client account is granted access to the second one or more data entries, to leave the second one or more fields unchanged in the data structure.

3. The system of claim 1, wherein the access profile is configured to indicate, for the first application, from the plurality of data entries, at least one of: the one or more data entries to which the second entity is not granted access, and a second one or more data entries to which the second entity is granted access.

4. The system of claim 1, wherein the third application is a data management application configured to store the plurality of data entries and provide, to the second application responsive to the API call of the second application, the plurality of data entries.

5. The system of claim 1, the one or more processors to:
select, by the first application responsive to identifying at least one of: the second application, the client account, and the plurality of data entries of the client account, the access profile; and
determine, by the first application using the access profile, to intercept the API response for modification of the API response prior to transmission of the modified API response to the second application.

6. The system of claim 1, the one or more processors to:
identify, by the first application parsing at least one of the API call and the API response, at least one of the client account and the plurality of data entries requested by the second application; and
intercept, by the first application, responsive to determining that the client account is associated with the access profile indicating at least one of the second application or the client account, the API response from the third application destined for the second application.

7. The system of claim 1, the one or more processors to:
generate, by the first application, a query for a database relating the plurality of client accounts that include the client account with the plurality of access profiles that include the client profile; and
receive, by the first application from the database responsive to the query, an indication that the second application is not granted access to at least one entry of the client account associated with the access profile.

8. The system of claim 1, the one or more processors to:
identify, from a plurality of fields included in the API response, a field of the access profile associated with the client account; and
determine, based on an indication for the field of the access profile, to exclude from the data structure the field to which the second application is not granted access.

9. The system of claim 1, the one or more processors to:
identify, from a plurality of fields included in the API response, a second field of the access profile associated with the client account; and
determine, based on a second indication for the second field of the access profile, to not exclude from the data structure the second field to which the second application is granted access.

10. The system of claim 1, the one or more processors to:
identify, by the first application, a format of the data structure of the API response destined for the second application; and
modify, by the first application, the data structure of the API response to remove from the data structure the one or more fields while maintaining the format of the data structure.

11. The system of claim 1, wherein the format of the data structure is a JavaScript Object Notation (JSON) object format.

12. The system of claim 1, the one or more processors to:
identify, by the first application that the API response from the third application includes an indication of an error; and
maintain the indication of the error unchanged in data structure of the modified API response.

13. The system of claim 1, the one or more processors to:
identify, by the first application, a log for recording the modified API response; and
store, within the log, one or more indications of the one or more fields excluded from the data structure.

14. The system of claim 1, the one or more processors to:
encode, by the first application, the data structure of the modified API response in a format that is compatible with a security protocol of at least one of: the client account or the second application, wherein the modified API response is transmitted to the second application in response to the encoding of the modified API response.

15. The system of claim 1, the one or more processors to:
identify, by the first application, an error condition based on a discrepancy of the modified API response; and
generate, by the first application, an error message for the modified API response based on the error condition.

16. A method, comprising:
identifying, by one or more processors coupled with memory via a first application for control of data access of a second application associated with a client account, an application programming interface (API) call requesting a plurality of data entries from a third application;
receiving, by the one or more processors from the third application in response to the API call, an API response destined for the second application, the API response including a data structure that includes the plurality of data entries;
selecting, by the one or more processors, responsive to the API response, an access profile from a plurality of access profiles, wherein the access profile is associated with the client account;
determining, by the one or more processors using the access profile, that the client account is not granted access to one or more data entries of the plurality of data entries included in the API response;
modifying, by the one or more processors in response to the determination, the API response to exclude from the data structure the one or more fields; and
transmitting, by the one or more processors to the second application associated with the client account, in response to the API call, the modified API response excluding the one or more fields from the data structure.

17. The method of claim 16, comprising the one or more processors to:
determining, by the one or more processors, that that client account is granted access to a second one or more data entries of the plurality of data entries included in the data structure; and
determining, by the one or more processors responsive to the determination that the client account is granted access to the second one or more data entries, to leave the second one or more fields unchanged in the data structure.

18. The method of claim 16, wherein the second application is an application associated with a second entity that is different than an entity associated with the client account and the access profile is configured to indicate, for the first application, from the plurality of data entries, at least one of: the one or more data entries to which the second entity is not granted access and a second one or more data entries to which the second entity is granted access, and wherein the third application is a data management application configured to store the plurality of data entries and provide, to the second application responsive to the API call of the second application, the plurality of data entries.

19. The method of claim 16, comprising:
selecting, by the one or more processors responsive to identifying at least one of: the second application, the client account, and the plurality of data entries of the client account, the access profile; and
determining, by the one or more processors using the access profile, to intercept the API response for modification of the API response prior to transmission of the modified API response to the second application.

20. A non-transitory computer-readable medium storing processor-executable instructions that, when executed by one or more processors, cause the one or more processors to:
identify, by a first application for control of data access of a second application associated with a client account, an application programming interface (API) call requesting a plurality of data entries from a third application;
receive, by the first application from the third application in response to the API call, an API response destined for the second application, the API response including a data structure that includes the plurality of data entries;
select, by the first application, responsive to the API response, an access profile from a plurality of access profiles, wherein the access profile is associated with the client account;
determine, by the first application using the access profile, that the client account is not granted access to one or more data entries of the plurality of data entries included in the API response;
modify, by the first application in response to the determination, the API response to exclude from the data structure the one or more fields; and
transmit, by the first application to the second application associated with the client account, in response to the API call, the modified API response excluding the one or more fields from the data structure.
